(19) United States
(12) Patent Application Publication
(10) Pub. No.: US 2020/0026479 A1
(43) Pub. Date: Jan. 23, 2020

(54) Operating Method and Related Operating System

(71) Applicant: Wistron Corporation, New Taipei City (TW)

(72) Inventor: Feng-Yuan Chen, New Taipei City (TW)

(21) Appl. No.: 16/214,115

(22) Filed: Dec. 9, 2018

(30) Foreign Application Priority Data
Jul. 18, 2018 (TW) 107124771

(51) Int. Cl. G06F 3/147; G06F 3/0487; G06F 3/0482; G06F 3/0483

(52) U.S. Cl. CPC G06F 3/147; G06F 3/0487; G06F 2203/04803; G06F 3/0483; G06F 3/0482

(57) ABSTRACT

An operating method is applied for a display device. The display device displays a plurality of display areas, wherein a first display area of the plurality of display areas shows images of a first computer device, and the first computer device is controlled by an input device. The operating method includes steps of determining whether an input signal generated by a user through the input device is operated in a second display area different from the first display area in the plurality of display areas; and when the input signal generated by the user is operated in the second display area, displaying a menu window.

### BACKGROUND OF THE INVENTION

### 1. Field of the Invention

The present invention relates to an operating method and related operating system, and more particularly, to an operating method and related operating system capable of enhancing operating efficiency without extra hardware device.

### 2. Description of the Prior Art

To accommodate requirements of the consumers, most of the conventional display devices have various display modes, such as Picture in Picture (PIP) and Picture by Picture (PBP), so as to simultaneously display images of different computer devices, and accordingly enhance operating efficiency.

However, when the conventional display device is to switch to the PIP or PBP mode, the user has to execute a function of On Screen Display (OSD), which is different from input devices used by the user for controlling the computer device, such as mouse, keyboard, remote controllers. Thus, the user has to use control keypads or devices disposed in a panel to trigger the OSD function, so as to switch the display mode of the display device, which requires extra hardware disposition and reduces the operating efficiency of the user.

Therefore, there is a need to improve over the prior art.

### SUMMARY OF THE INVENTION

It is therefore a primary objective of the present invention to provide an operating method and related operating system capable of enhancing the operating efficiency of the user.

In an aspect, the present invention provides an operating method, utilized in a display device, wherein the display device displays a plurality of display areas, a first display area of the plurality of display areas shows images of a first computer device, and the first computer device is controlled by an input device. The operating method comprises determining whether an input signal generated by a user through the input device is operated in a second display area different from the first display area in the plurality of display areas; and when the input signal generated by the user is operated in the second display area, displaying a menu window.

In another aspect, the present invention provides an operating system, which comprises at least a computer device, configured to perform computing operations; an input device, configured to receive operations of a user to generate an input signal for controlling the at least a computer device; and a display device, coupled to the at least a computer device and the input device, comprising a universal serial bus (USB) multiplexer, coupled to the at least a computer device; a panel, coupled to the USB multiplexer, for displaying images; and a processing unit, coupled to the input device and the USB multiplexer, configured to control operations of the USB multiplexer and images displayed by the panel according to the input signal of the input device; wherein when the panel displays a plurality of display areas, and a first display area of the plurality of display areas displays images of a first computer device of the at least a computer device, and the first computer device is controlled by the input device, the processing unit determines whether an input signal generated by the user through the input device is operated in a second display area different from the first display area in the plurality of display areas; and displays a menu window when the input signal generated by the user is operated in the second display area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an operating system according to an embodiment of the present invention.

FIG. 2 illustrates a flowchart of an operating process according to an embodiment of the present invention.

FIG. 3 illustrates operations of the operating system shown in FIG. 1 when the number n of the computer devices equals 2.

FIG. 4 illustrates a schematic diagram of a frame displayed by a panel according to an embodiment of the present invention.

FIGS. 5A, 5B illustrate schematic diagrams of frames displayed by a panel according to an embodiment of the present invention.

FIG. 6 illustrates a schematic diagram of a frame displayed by a panel according to an embodiment of the present invention.

FIG. 7 illustrates a schematic diagram of a frame displayed by a panel according to an embodiment of the present invention.

### DETAILED DESCRIPTION

Certain terms are used in the following description and claims to refer to particular components. Those skilled in the art will appreciate, manufacturers may use different terms to refer to a component. This document does not intend to follow the difference component distinguished name as a way to differentiate components but functionally distinguished as a criterion. Mentioned in the following description and claims the terms “include” or “comprising” is an open-ended fashion, and thus should be interpreted to mean “including/include but not limited to.” Except, “coupled” are intended to mean either an indirect or direct electrical connection. Accordingly, described herein if a device is coupled to a second device, said first means represents may be directly electrically connected to said second means, or by connecting to other devices or indirectly electrically connected to said first means second means.

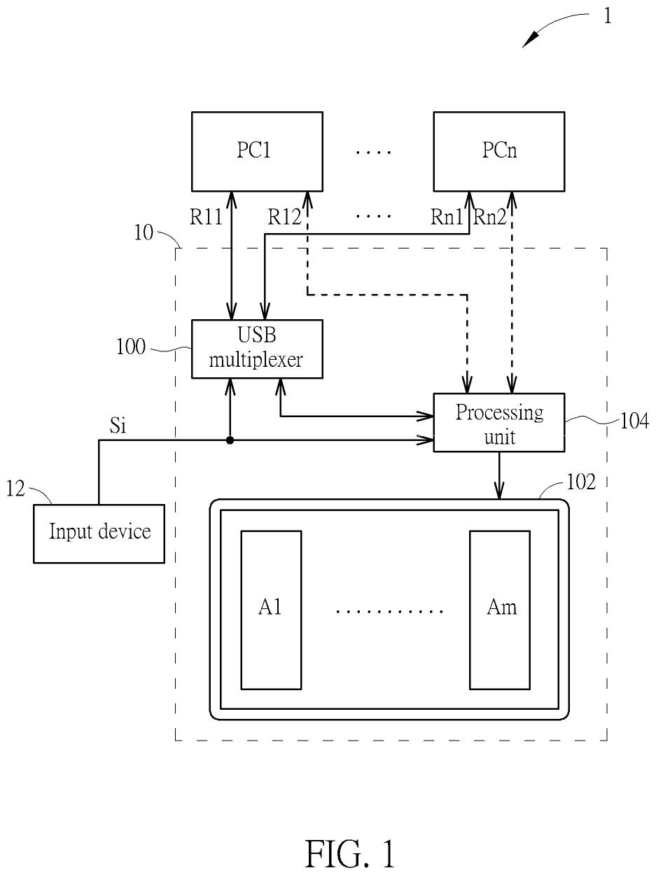

Please refer to FIG. 1, which is a schematic diagram of an operating system 1 according to an embodiment of the present invention. The operating system 1 includes a display device 10, an input device 12 and the computer devices PC1-PCn. Specifically, the operating system 1 may display images of the computer devices PC1-PCn on the display device 10, and the user may operate the input device 12 to control a selected computer device, or selectively operate the computer devices PC1-PCn via images displayed on the display device 10, so as to enhance convenience.

The display device 10 displays display areas A1-Am by a Picture in Picture (PIP) mode, a Picture by Picture (PBP) mode, or any other modes, which is not limited thereto. The number m of the display areas A1-Am may be appropriately adjusted according to different applications or design requirements. For example, the display device may have two display areas (i.e., the display areas A1 and A2), for displaying images of any two computer devices selected by the user within the computer devices PC1-PCn. Alternatively, the display device 10 may have display areas A1-An corresponding to the computer devices PC1-PCn, such that each of the computer devices PC1-PCn may be displayed in a corresponding area of the display areas A1-An in the display device 10. Therefore, by switching to different display modes, the operating system. 1 may change configuration of the display areas or adjust to display images of the selected computer device indifferent display areas, such that the operating system 1 may adjust the display modes without additional hardware devices, to fulfill the user's requirements and enhance the operating efficiency.

Specifically, images of the computer device selected by the user would be displayed in a corresponding display area within the display areas A1-Am, and the user may operate the selected computer device via the input signal Si; meanwhile, the input signal Si cannot control the computer devices not selected by the user.

Please continue to refer to FIG. 1. In order to receive images signals of the computer devices PC1-PCn and the input signal Si of the input device 12, the display device 10 includes a Universal Serial Bus (USB) multiplexer 100, a panel 102 and a processing unit 104. The USB multiplexer 100 is configured to selectively transmit the input signal Si to the selected computer device according to determination of the processing unit 104. The panel 102 is configured to display images of the computer devices PC1-PCn in a display mode determined by the user according to computing results of the processing unit 104. The processing unit 104 is coupled to the computer devices PC1-PCn, and configured to receive images transmitted from the computer devices PC1-PCn, and combine the images of the computer devices PC1-PCn into images suitable for the definition of the panel 102 according to the display mode determined by the user, so as to display on the panel 102. In addition, the processing unit 104 is further coupled to the USB multiplexer 100 and the input device 12, for receiving the input signal Si generated by the input device 12, to determine whether the user operates in a specified display area corresponding to the selected computer device according to the input signal Si, so as to instruct the USB multiplexer 100 to switch the computer device controlled by the input device 12. In such a situation, when the user operates in the display area corresponding to the selected computer device, the processing unit 104 may instruct the USB multiplexer 100 to transmit the input signal Si to the selected computer device; or, when the user operates outside the display area corresponding to the selected computer device, the user may perform a switching operation, in which the processing unit 104 instructs the USB multiplexer 100 to switch the input signal Si to other computer devices.

Note that, the processing unit 104 may be a microprocessor (MCU), an application-specific integrated circuit (ASIC) or a video signal scaler, for processing image signals transmitted by the computer device, and adjusting the image signals to display on the panel 102. Moreover, the USB multiplexer 100 may include multiple USB multiplexers corresponding to different standards/specifications, and the different USB multiplexers may be serially or parallel connected and integrated as the USB multiplexer 100. In another aspect, according to various application or design requirements, the input device 12 may be an independent device separated from the display device 10 and operated by the user, such as a keyboard, a mouse, a remote control device, a graphics tablet, a motion sensing camera, a motion sensing grip, etc. Alternatively, the input device 12 may be integrated in the display device 10, such as a touch panel, control pads disposed on the display device 10, etc. As long as the user may use the input device 12 to manipulate the selected computer device without extra hardware devices and the operating system. 1 may receive the input signal Si generated by the input device 12, the input device 12 may be implemented by various devices or circuits. In addition, as shown in FIG. 1, the input signal Si generated by the input device 12 is transmitted to the USB multiplexer 100 and the processing unit 104. In different embodiments, the input signal Si generated by the input device 12 may be first transmitted to the USB multiplexer 100, and then to the processing unit 104, which is also within the scope of the present invention.

In FIG. 1, the computer devices PC1-PCn and the USB multiplexer 100 are connected through routes R11-Rn1, and routes R12-Rn2 illustrated as dotted lines between the computer devices PC1-PCn and the processing unit 104 represent that under different USB standards, the computer devices PC1-PCn and the display device 10 may require the additional routes R12-Rn2 to accurately transmit the input signal Si and image signals of the computer devices PC1-PCn. In detail, when the routes R11-Rn1 between the computer devices PC1-PCn and the USB multiplexer 100 conform to the USB type-C specification, since the transmission bandwidth thereof is high enough to simultaneously transmit the input signal Si, image signals, etc., the computer devices PC1-PCn and the display device 10 may simultaneously achieve transmissions of the input signal Si, the image signals, etc. only though the routes R11-Rn1. On the other hand, when the routes R11-Rn1 between the computer devices PC1-PCn and the USB multiplexer 100 conform to the USB type-A specification, since the transmission bandwidth thereof is insufficient to simultaneously transmit the input signal Si and image signals, the computer devices PC1-PCn and the processing unit 104 may require the routes R12-Rn2 to transmit the image signals. In other words, when the routes R11-Rn1 are of USB type-A, the input signal Si of the user is transmitted to the computer devices PC1-PCn via the routes R11-Rn1, and the image signals of the computer devices PC1-PCn are transmitted to the processing unit 104 through the additional routes R12-Rn2 to be displayed by the panel 102. The techniques of in-/decreasing transmission routes according to specifications of connecting interfaces or transmission bandwidths should be well known in the art, which is not limited thereto.

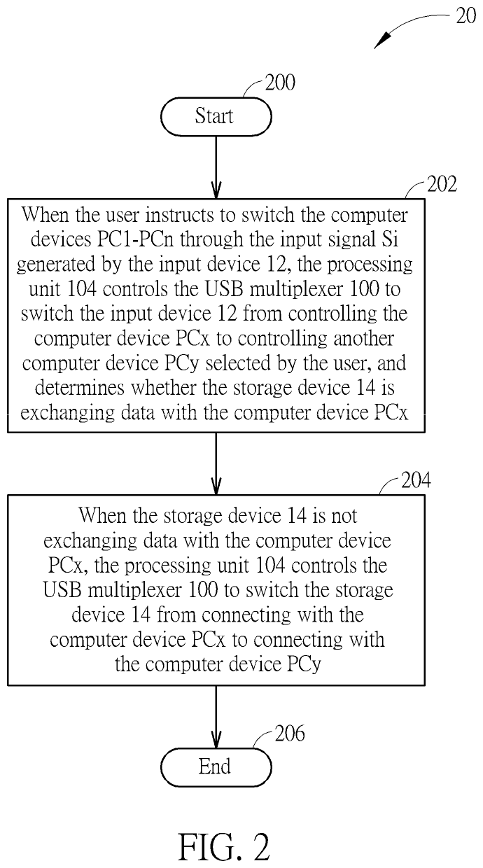

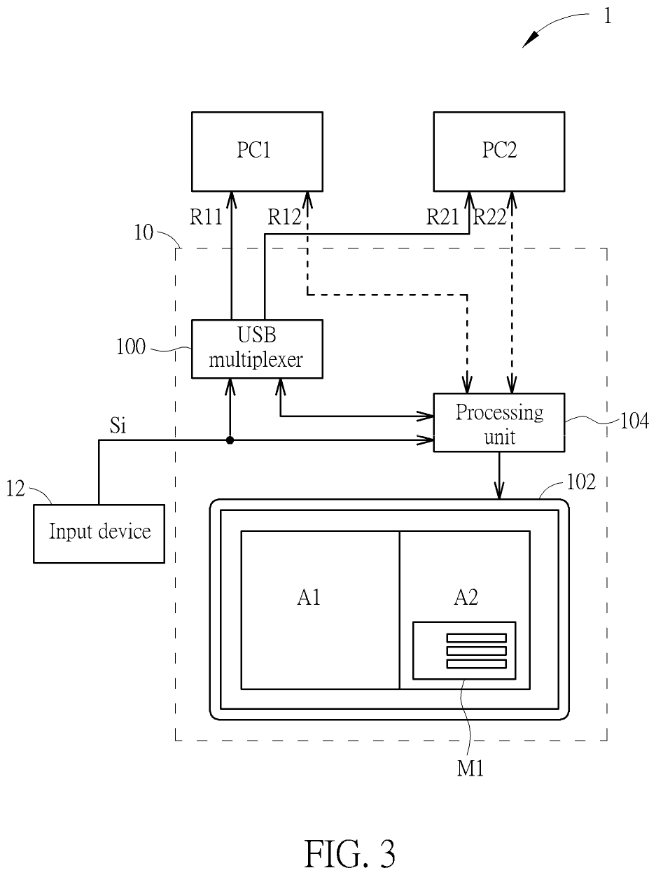

To explain operations of the operating system 1, the number n of the computer devices PC1-PCn equal to 2 is taken as an example in the following. Please refer to FIG. 2 and FIG. 3. FIG. 2 is a flowchart of an operating process 20 according to an embodiment of the present invention, and FIG. 3 illustrates operations of the operating system 1 when the number n of the computer devices PC1-PCn equals 2. In the embodiment, the operating system 1 includes the computer devices PC1 and PC2, and the display mode of the panel 102 is PBP, which displays the display areas A1 and A2. The user may operate the computer device PC1 in the display area A1 via the input device 12, and watch images of the computer device PC2 in the display area A2. As shown in FIG. 2, the operating process 20 includes the following steps:

Step 200: Start.

Step 202: Determine whether the input signal Si generated by the user through the input device 12 operates in the display area A2 different to the display area A1.

Step 204: When the input signal Si generated by the user operates in the display area A2, display a menu window Ml.

Step 206: End.

According to the operating process 20, in Step 202, the processing unit 104 receives the input signal Si, and determines whether the user operates in the display area A1 corresponding to the selected computer device PC1. When the user operates in the display area A1, the processing unit 104 instructs the USB multiplexer 100 to transmit the input signal Si to the selected computer device PC1. When the user operates outside the display area A1 (i.e. in the display area A2), the processing unit 104 instructs the USB multiplexer 100 not to transmit the input signal Si to the selected computer device PC1. Meanwhile, in Step 204, when the processing unit 104 determines that the user operates outside the display area A1, the processing unit 104 may display a menu window Ml on the panel 102, and the user may select an item within the menu window Ml to instruct the operating system 1 to perform the corresponding switching operation. For example, the user may select not to switch the computer device according to the menu window Ml, or select to switch to the computer device PC2. The processing unit 104 may generate an operating result according to the selection made by the user operating on the menu window Ml, and accordingly instruct the USB multiplexer 100 to switch the input signal Si. That is, when the operating result indicates that the user instructs to switch the selected computer device to the computer device PC2, the processing unit 104 may instruct the USB multiplexer 100 to switch the input signal Si to the computer device PC2, and the user may operate the computer device PC2 in the display area A2. In addition, the user may also manipulate the menu window Ml to generate an operating result for switching the display mode of the panel 102, and the processing unit 104 may accordingly control the panel 102 to operate in different configurations. For example, when the user instructs to switch the display mode of the panel 102 to PIP, the user may further determine signal sources of each display area to generate a corresponding operating result, and the processing unit 104 may accordingly switch the display mode of the panel 102 to PIP, to fulfill the user's requirement.

Note that, the menu window Ml in the embodiment of the present invention may be realized according to different applications and design requirements. For example, the menu window Ml may be an On Screen Display (OSD) function or a system menu, as long as the user may utilize the input device 12 to operate the menu window Ml. Moreover, the menu window Ml may be located in various positions, e.g. the menu window Ml may be displayed in the center of the display area A2, or at a position corresponding to where the user performs touch control to generate the input signal Si, or at a position corresponding to where the user uses a mouse cursor to generate the input signal Si. The user operates on the menu window Ml displayed in the display area A2 to generate the operating result, and the processing unit 104 performs the corresponding switching operation according to the operating result, so as to switch the computer device and the display mode of the panel 102. As a result, the operating system 1 of the embodiment of the present invention may determine the computer device selected by the user via the processing unit 104, to accurately switch the USB multiplexer 100, such that the input signal Si generated by the input device 102 may be transmitted to the selected computer device via the USB multiplexer 100.

In short, via the operating system 1, the user may operate on the specified display area of the panel 102 to manipulate the selected computer device, and operate outside the specified display area of the panel 102 to trigger the menu window Ml so as to switch the selected computer device and adjust the display mode of the panel 102. Therefore, the operating system 1 of the embodiment of the present invention uses all the display areas of the panel 102 to control the computer device, switch the computer device or switch the display mode, thereby enhancing the operating convenience and the flexibility for setting the display mode. Consequently, the operating system 1 may fulfill the user's requirements and enhance the user's satisfactory.

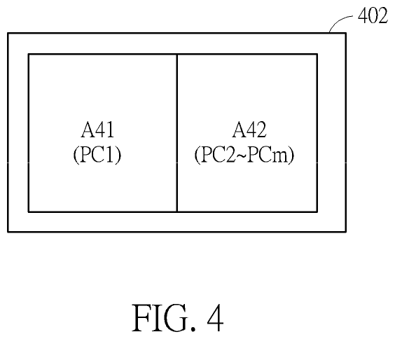

Note that, FIG. 3 illustrates the embodiment that the number n of the computer devices PC1-PCn equals 2 in the operating system 1, and those skilled in the art may make modifications, which is not limited thereto. For example, please refer to FIG. 4, which is a schematic diagram of a frame 402 displayed by the panel 102 according to an embodiment of the present invention. For simplicity, the frame 402 represents a picture displayed by the panel 102 when the operating system 1 comprises computer devices PC1-PCm, and 2<m<n. In other words, there are more than two computer devices operating in the operating system 1. Furthermore, the frame 402 refers to the PBP mode, and includes display areas A41 and A42. The user may operate on the display area A41 via the input device 12 to control the selected computer device PC1. The display area A42 may display images of any one of the computer devices PC2-PCm, or may not display any image (e.g. to display a black image). When the user operates on the display area A42 outside the display area A41, the processing unit 104 may switch the selected computer device according to the menu window Ml generated by the input signal Si of the user. Accordingly, using the menu window Ml, the user may select a computer device from the computer devices PC2-PCm to be controlled in the display area A42, and generate the corresponding operating result, such that the processing unit 104 may correspondingly instruct the USB multiplexer 100 to switch the input signal Si and display images of the selected computer device in the display area A42.

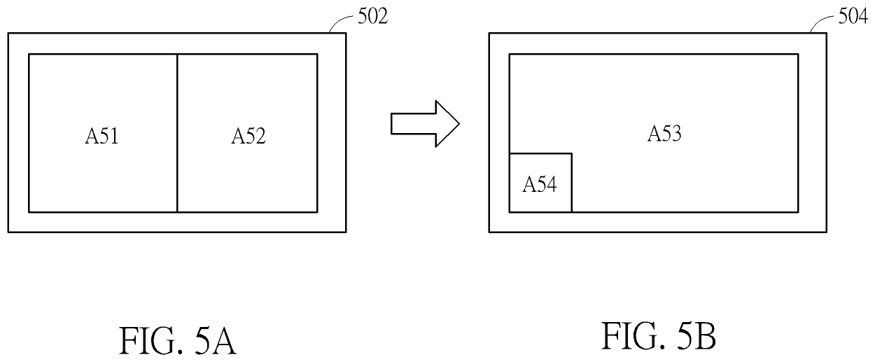

Please refer to FIGS. 5A and 5B, which are schematic diagrams of frames 502 and 504 displayed by the panel 102 according to an embodiment of the present invention. The frame 502 represents a picture displayed by the panel 102 before the processing unit 104 switches the display mode, and the frame 504 represents a picture displayed by the panel 102 after the processing unit 104 switches the display mode. As shown in FIG. 5A, the frame 502 refers to the PBP mode, and comprises display areas A51 and A52, and the user may use the input device 12 to control the selected computer device PC1 in the display area A51. In this embodiment, after the user operates on the display area A52 to trigger the menu window Ml, the user can manipulate the menu window Ml to generate an operating result for switching the display mode of the panel 102 from PBP to PIP. Therefore, as shown in FIG. 5B, the original frame 502 is switched to the frame 504 by the user, which comprises display areas A53 and A54. The user may further decide computer devices to be shown in the display areas A53 and A54.

Please refer to FIG. 6, which is a schematic diagram of a frame 602 displayed by the panel 102 according to an embodiment of the present invention. In the embodiment, the user may use the menu window Ml to change the number of the display areas displayed by the panel 102, and to select computer devices to be shown in the display areas, such that the panel 102 may have the display mode of 9-grid (including display areas A61-A69) or 16-grid, as shown in the frame 602, which is different to the display areas A1 and A2 shown in FIG. 3 or the display areas A41 and A42 shown in FIG. 4.

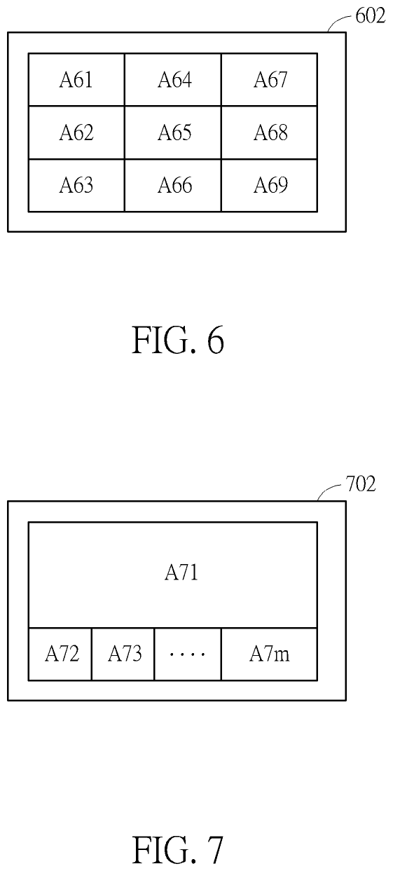

In addition, please refer to FIG. 7, which is a schematic diagram of a frame 702 displayed by the panel 102 according to an embodiment of the present invention. In the embodiment, the user may also use the menu window Ml to adjust the number of sub-pictures when the panel 102 operates in PIP. In detail, when the user decides to change to PIP, the user may operate on the menu window Ml to decide the number of sub-pictures in PIP and signal sources of the major picture and the sub-pictures. Therefore, as shown in FIG. 7, when the panel 102 operates in PIP, the panel 102 may display a display area A71 showing the major picture and display areas A72-A7m showing the sub-pictures. Certainly, the user may further operate on the menu window Ml to select computer devices to be shown in each display area, which increases the system flexibility of the operating system 1. Moreover, except for adjusting the display mode of the panel and the number of the display areas, the operating system of the present invention may change locations, sizes and definitions of the plurality of display areas displayed by the display device, which is within the scope of the present invention, in order to further fulfill the user's requirements and enhance convenience of the operating system.

In the prior art, the user has to use extra hardware device, which is different from the device for controlling the computer device, to switch the display mode, thereby increasing the manufacturing cost and decreasing the efficiency of switching operation. In comparison, using the operating system of the present invention, the user may use the input device which is identical to the device for controlling the computer device to perform the switching operation; that is, the user may control the selected computer device by operating on the specified display area corresponding to the selected computer device in the display device, and trigger the menu window by operating outside the specified display area to switch the selected computer device or the display mode. Thus, without extra hardware device, the operating system of the present invention can fulfill the user's requirements and enhance convenience, thereby improving operating efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An operating method, utilized in a display device, wherein the display device displays a plurality of display areas, a first display area of the plurality of display areas shows images of a first computer device, and the first computer device is controlled by an input device, the operating method comprising:
determining whether an input signal generated by a user through the input device is operated in a second display area different from the first display area in the plurality of display areas; and
when the input signal generated by the user is operated in the second display area, displaying a menu window.

2. The operating method of claim 1, further comprising:
receiving an operating result of the user operating the menu window; and
determining whether to perform a switching operating according to operating result.

3. The operating method of claim 2, wherein the second display area displays images of a second computer device, and the switching operation is switching the input device from controlling the first computer device to controlling the second computer device.

4. The operating method of claim 2, wherein the switching operation is changing at least one of locations, sizes and definitions of the plurality of display areas displayed by the display device.

5. An operating system, comprising:
at least a computer device, configured to perform computing operations;
an input device, configured to receive operations of a user to generate an input signal for controlling the at least a computer device; and
a display device, coupled to the at least a computer device and the input device, comprising:
a universal serial bus (USB) multiplexer, coupled to the at least a computer device;
a panel, coupled to the USB multiplexer, for displaying images; and
a processing unit, coupled to the input device and the USB multiplexer, configured to control operations of the USB multiplexer and images displayed by the panel according to the input signal of the input device;
wherein when the panel displays a plurality of display areas, and a first display area of the plurality of display areas displays images of a first computer device of the at least a computer device, and the first computer device is controlled by the input device, the processing unit determines whether an input signal generated by the user through the input device is operated in a second display area different from the first display area in the plurality of display areas; and displays a menu window when the input signal generated by the user is operated in the second display area.

6. The operating system of claim 5, wherein the processing unit is further configured to receive an operating result of the user operating the menu window, and determine whether to perform a switching operating according to operating result.

7. The operating system of claim 6, wherein the second display area displays images of a second computer device of the at least a computer device, and the switching operation is the processing unit instructing the USB multiplexer to switch the input device from controlling the first computer device to controlling the second computer device.

8. The operating system of claim 6, wherein the switching operation is the processing unit controlling the panel to change at least one of locations, sizes and definitions of the plurality of display areas displayed by the display device.
